(19) United States
(12) Patent Application Publication
(10) Pub. No.: US 2025/0037199 A1
(43) Pub. Date: Jan. 30, 2025

(54) SYSTEMS AND METHODS FOR TRANSPARENT CONVERGENCE OF CLOUD AND ON-PREMISES DATA ANALYTICS AND SERVICES

(71) Applicant: JPMORGAN CHASE BANK, N.A., New York, NY (US)

(72) Inventors: Leon SIROTA, Armonk, NY (US); Kevin HOLSGROVE, New York, NY (US)

(21) Appl. No.: 18/781,468

(22) Filed: Jul. 23, 2024

Related U.S. Application Data
(60) Provisional application No. 63/515,518, filed on Jul. 25, 2023.

(51) Int. Cl. G06Q 40/04; G06N 20/00

(52) U.S. Cl. CPC G06Q 40/04; G06N 20/00

(57) ABSTRACT

A method may include: (1) receiving, by a backend, orders and requests for quotes from an electronic trade platform; (2) receiving, by the backend, trades and order lifecycle messages from a message service; (3) ingesting, by the backend, the orders, the requests for quotes, the trades, and the order lifecycle messages into one or more data stores; (4) identifying, by the backend, dimensions to evaluate using a trade reconciliation engine; (5) reconciling, by the backend, the trades using the trade reconciliation engine; (6) identifying, by the backend, dimensions for an order reconciliation engine; (7) reconciling, by the backend, the orders and the order lifecycle messages using the order reconciliation engine; (8) combining, by the backend, results of the trade reconciliation and the order reconciliation; and (9) outputting, by the backend, a score for the combined results of the trade reconciliation and the order reconciliation.

### RELATED APPLICATIONS

This application claims priority to U.S. Provisional Patent Application Ser. No. 63/515,518, filed Jul. 25, 2023, the disclosure of which is hereby incorporated, by reference, in its entirety.

### BACKGROUND OF THE INVENTION

### 1. Field of the Invention

Embodiments are generally directed to systems and methods for transparent convergence of cloud and on-premises data analytics and services.

### 2. Description of the Related Art

Conventional approaches to reconciling electronic trading activities is typically focused on trades (i.e., executions) only. This can lead to inaccurate results.

### SUMMARY OF THE INVENTION

Systems and methods for transparent convergence of cloud and on-premises data analytics and services are disclosed. In one embodiment, a method may include: (1) receiving, by a backend, orders and requests for quotes from an electronic trade platform; (2) receiving, by the backend, trades and order lifecycle messages from a message service (e.g., a service that receives lifecycle messages from markets, exchanges, and execution venues); (3) ingesting, by the backend, the orders, the requests for quotes, the trades, and the order lifecycle messages into one or more data stores; (4) identifying, by the backend, dimensions to evaluate using a trade reconciliation engine; (5) reconciling, by the backend, the trades using the trade reconciliation engine; (6) identifying, by the backend, dimensions for an order reconciliation engine; (7) reconciling, by the backend, the orders and the order lifecycle messages using the order reconciliation engine; (8) combining, by the backend, results of the trade reconciliation and the order reconciliation; and (9) outputting, by the backend, a score for the combined results of the trade reconciliation and the order reconciliation.

In one embodiment, the method may also include: determining, by the backend and based on the score, that retraining is needed; and retraining, by the backend, the trade reconciliation engine and/or the order reconciliation engine.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for transparent convergence of cloud and on-premises data analytics and services according to an embodiment;

FIG. 2 illustrates a method for transparent convergence of cloud and on-premises data analytics and services according to an embodiment; and

FIG. 3 depicts an exemplary computing system for implementing aspects of the present disclosure.

### DETAILED DESCRIPTION OF PREFERRED EMBODIMENTS

Systems and methods for transparent convergence of cloud and on-premises data analytics and services are disclosed.

Embodiments go beyond by embracing order-level reconciliation techniques which cover a complete universe of the electronic trading orders and Request for Quotes (RFQs), including those that have not resulted in execution.

Embodiments may execute various types of reconciliations (e.g., near real-time and periodic, using unique linkage, machine learning models, etc.) between the orders and RFQs published by electronic trading platforms and the messages received from independent reference sources, such as venue message services. Embodiments may apply similar concepts to the datasets exposed via API to surveillance platforms. Reconciliation processes may be declared, configured, and run within a macro knowledge database time-series data platform.

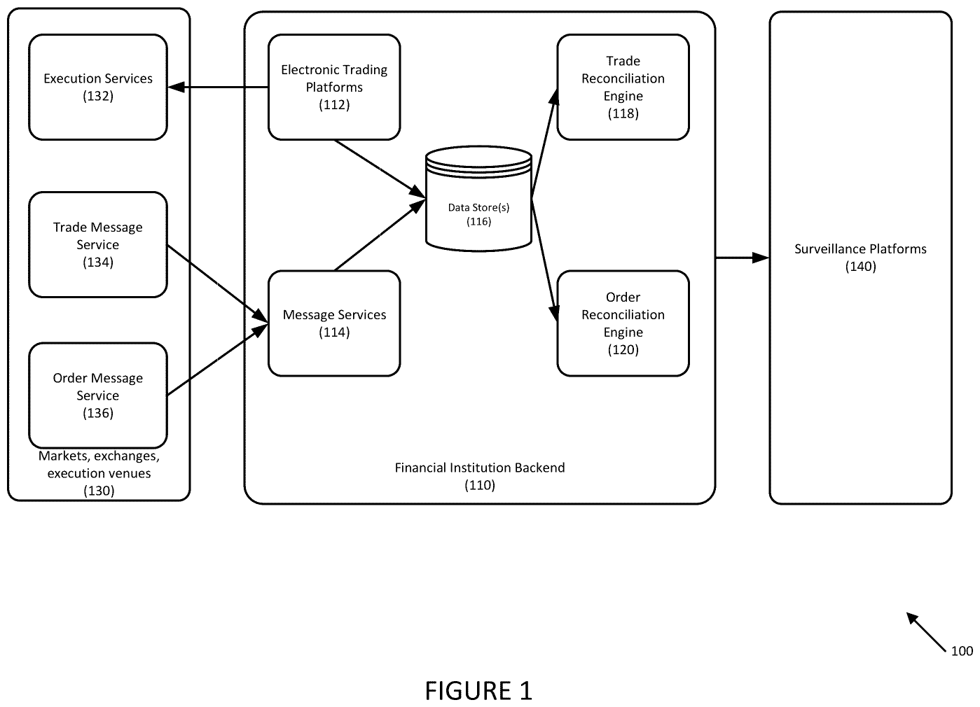

Referring to FIG. 1, a system for transparent convergence of cloud and on-premises data analytics and services is disclosed according to an embodiment. System 100 may include markets, exchanges, execution venues 130, which may include execution services 132, trade message service 134, order message service 136, etc. Execution services 132 may receive orders and RFQs from electronic trading platforms 112. Trade message service 134 and order message service 136 receive trade lifecycle messages and order lifecycle messages, respectively, from markets, exchanges, execution venues 130, and may provide them to message service 114.

Electronic trading platforms 112 may provide orders and RFQs to a macro knowledge database in financial institution backend 110, which may include datastores 116, trade reconciliation engine 118, and order reconciliation engine 120. Financial institution backend 110 may further provide data access to surveillance platforms 140 via API. For example, orders and RFQs may be provided to surveillance platforms 140, such as corporate compliance platforms, via a trading activities API (not shown).

Reconciliation engines 118 and 120 may be responsible for ensuring completeness (or detecting gaps) between messages transmitted to/from markets, exchanges, venues 130 and those received by surveillance platforms 140.

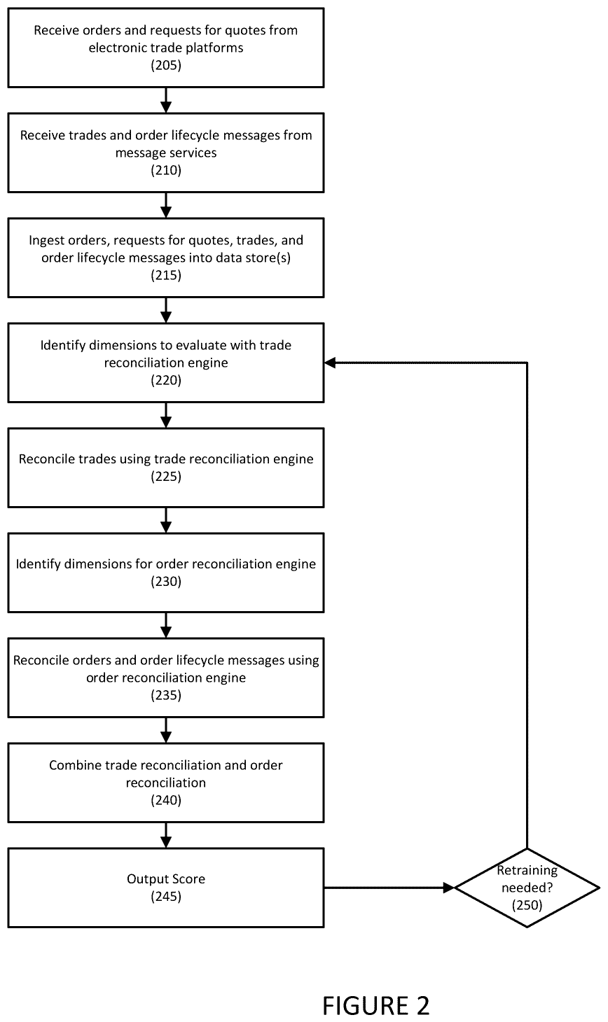

Referring to FIG. 2, a method for transparent convergence of cloud and on-premises data analytics and services is disclosed according to an embodiment.

In step 205, a financial institution backend may receive orders and requests for quotes from one or more electronic trade platforms.

In step 210, the financial institution backend may receive trades and order lifecycle messages from message service.

In step 215, the financial institution backend may receive and ingest the orders, requests for quotes, trades, and order lifecycle messages into data store(s).

In step 220, the financial institution backend may identify dimensions to evaluate with a trade reconciliation engine.

In step 225, the financial institution backend may reconcile trades using a trade reconciliation engine.

In step 230, the financial institution backend may identify dimensions for an order reconciliation engine.

In step 235, the financial institution backend may reconcile orders and order lifecycle messages using the order reconciliation engine.

In step 240, the financial institution backend may combine the results of the trade reconciliation and the order reconciliation, and in step 245, may output a score to, for example, a surveillance platform, such as a corporate compliance platform.

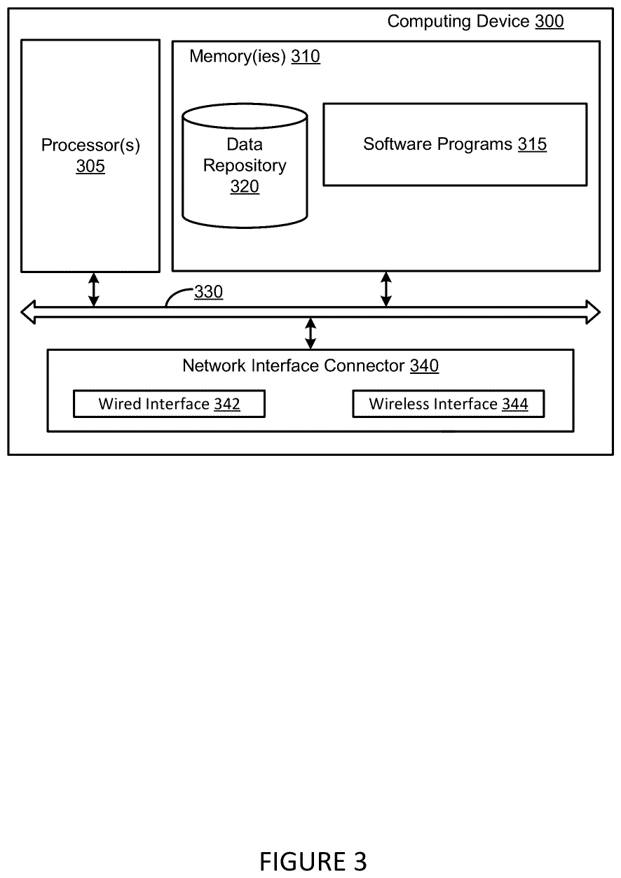

In step 250, the financial institution backend may determine if retraining is needed. If so, the process may return in step 220. FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity, i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method, comprising:
receiving, by a backend, orders and requests for quotes from an electronic trade platform;
receiving, by the backend, trades and order lifecycle messages from a message service;
ingesting, by the backend, the orders, the requests for quotes, the trades, and the order lifecycle messages into one or more data stores;
identifying, by the backend, dimensions to evaluate using a trade reconciliation engine;
reconciling, by the backend, the trades using the trade reconciliation engine;
identifying, by the backend, dimensions for an order reconciliation engine;
reconciling, by the backend, the orders and the order lifecycle messages using the order reconciliation engine;
combining, by the backend, results of the trade reconciliation and the order reconciliation; and
outputting, by the backend, a score for the combined results of the trade reconciliation and the order reconciliation.

2. The method of claim 1, further comprising:
determining, by the backend and based on the score, that retraining is needed; and
retraining, by the backend, the trade reconciliation engine and/or the order reconciliation engine.
